(19) United States
(12) Patent Application Publication
(10) Pub. No.: US 2016/0259751 A1
(43) Pub. Date: Sep. 8, 2016

(54) MOTHERBOARD

(71) Applicant: ASUSTeK COMPUTER INC., Taipei City (TW)

(72) Inventors: Bing-Min Lin, Taipei City (TW); Ji-Kuang Tan, Taipei City (TW); Teng-Liang Ng, Taipei City (TW); Ho-Jui Kao, Taipei City (TW)

(21) Appl. No.: 15/052,804

(22) Filed: Feb. 24, 2016

(30) Foreign Application Priority Data
Mar. 6, 2015 (TW) 104107278

(51) Int. Cl. G06F 13/40

(52) U.S. Cl. CPC G06F 13/4068

(57) ABSTRACT

A motherboard including a socket and a memory slot is provided. The socket is adapted for disposing a processor with at least one memory channel, and each of the memory channels supports at least two memory cards. The memory slot is coupled to the socket and transmits signals from the memory channel. The memory slot includes a plurality of pins. A first part of the pins of the memory slot is assigned to transmit a signal from one of the memory cards supported by the memory channel, and a second part of the pins of the memory slot is assigned to transmit a signal from another one of the memory cards supported by the memory channel.

### CROSS-REFERENCE TO RELATED APPLICATION

This application claims the priority benefit of Taiwan application serial No. 104107278, filed on Mar. 6, 2015. The entirety of the above-mentioned patent application is hereby incorporated by references herein and made a part of specification.

### BACKGROUND OF THE INVENTION

1. Field of the Invention

The invention relates to a motherboard and, more specifically, to a motherboard with expanded memory slots.

2. Description of the Related Art

A motherboard is a core component for connecting various functional modules in a computer system. It provides a plurality of interfaces for interconnecting the functional modules, such as a processor, a graphics card, a hard disk and a memory, so that the functional modules can communicate with each other via the motherboard. Conventionally, motherboards that support a dual-channel technology usually includes two configurations (i.e., a motherboard with two memory slots and a motherboard with four memory slots) available for a user according to individual requirements.

A motherboard with four memory slots supports a larger memory capacity, and four memory cards can be inserted to the computer system at most. However, circuits may be tangled between these memory slots. When the motherboard with four memory slots is overclocked, residual circuits between the adjacent memory slots would affect the transmission quality and the capacity of the overclocking.

A motherboard with two memory slots has a better overclocking performance without the tangled circuits problem. However, since only two memory cards can be inserted in the two memory slots, the memory capacity supported by the motherboard is limited.

### BRIEF SUMMARY OF THE INVENTION

According to a first aspect of the present disclosure, a motherboard comprises: a socket adapted for disposing a processor with at least one memory channel, wherein each of the memory channels supports at least two memory cards; and a memory slot coupled to the socket and transmitting signals from the memory channel, wherein the memory slot includes a plurality of pins, a first part of the pins of the memory slot is assigned to transmit a signal from one of the memory cards supported by the memory channel, and a second part of the pins of the memory slot is assigned to transmit a signal from another one of the memory cards supported by the memory channel.

In sum, the signals from different memory cards can be transmitted through the same memory slot. Therefore, residual circuits have less impact while overclocking performance. Furthermore, with the configuration of the expanded modules, the motherboard has additional memory capacity. Therefore, the overclocking performance and the memory capacity are both satisfied.

### BRIEF DESCRIPTION OF THE DRAWINGS

These and other features, aspects and advantages of the invention will become better understood with regard to the following embodiments and accompanying drawings.

FIG. 1 is a schematic diagram showing a motherboard in an embodiment;

FIG. 2 is a schematic diagram showing a motherboard in an embodiment;

FIG. 3 is a schematic diagram showing a connection between a memory slot and an expanded module in an embodiment;

FIG. 4A is a schematic diagram showing a configuration of a motherboard in an embodiment;

FIG. 4B is a schematic diagram showing a configuration of a motherboard in an embodiment;

FIG. 4C is a schematic diagram showing a configuration of a motherboard in an embodiment;

FIG. 5 is a schematic diagram showing an expanded module in an embodiment.

### DETAILED DESCRIPTION OF THE EMBODIMENTS

To better understand the disclosures of the invention, embodiments are set forth below as examples implementing the invention. In addition, same or similar component/structure/step is denoted by a same number throughout the figures.

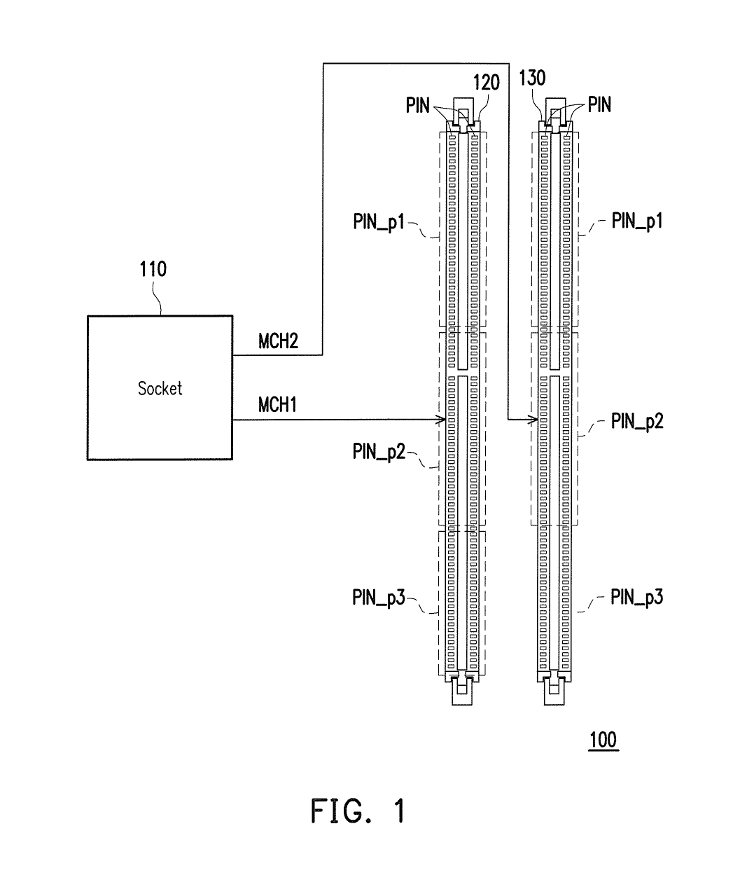

FIG. 1 is a schematic diagram showing a motherboard in an embodiment. Referring to FIG. 1, a motherboard 100 includes a socket 110, a first memory slot 120 and a second memory slot 130.

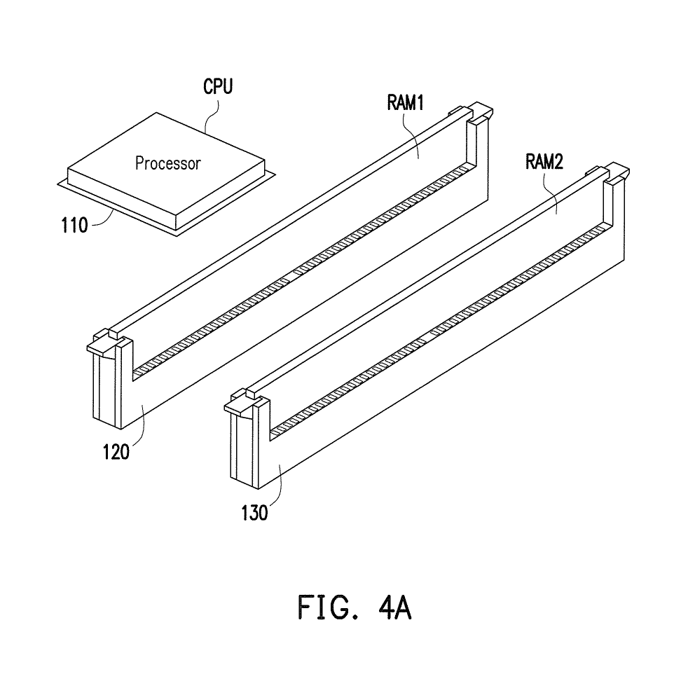

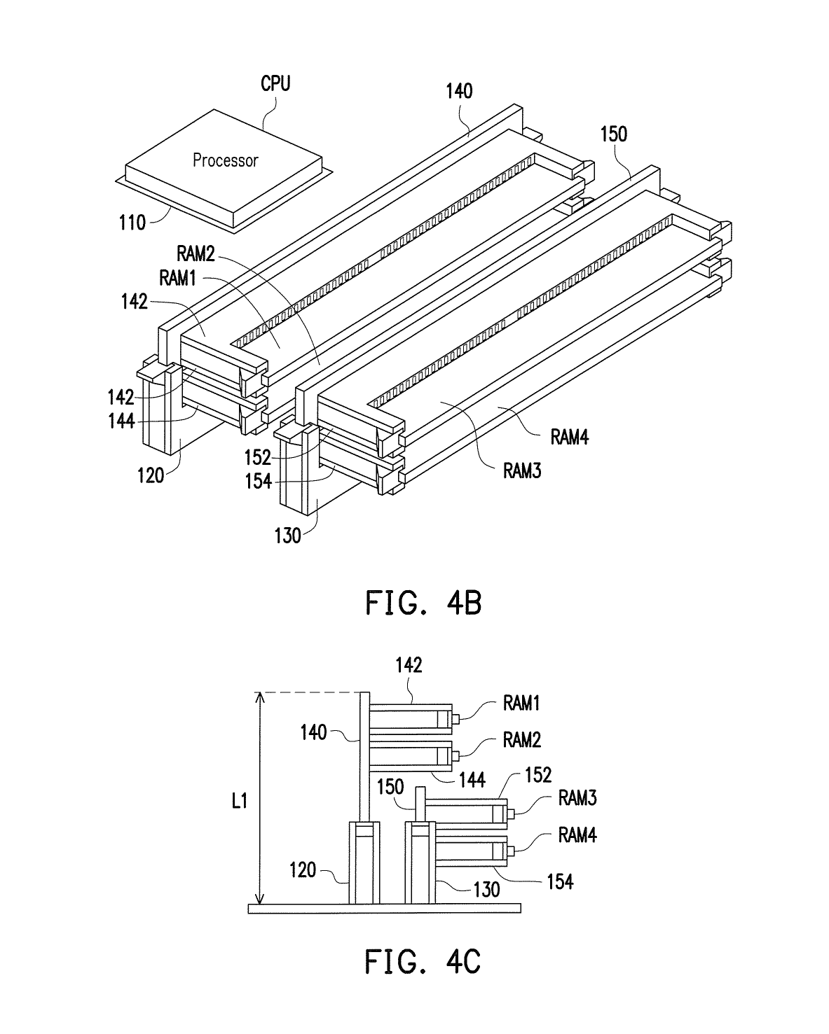

A processor (such as a CPU) is adapted to be configured to the socket 110. The processor supports a dual-channel memory access technology. When the processor is disposed in the socket 110, the processor accesses memory cards (such as RAM1,RAM2 in FIG. 4A) installed in the first memory slot 120 and the second memory slot 130 via memory channels MCH1 and MCH2, respectively. In the embodiment, each memory channel MCH1 and MCH2 supports an access of two memory cards based on the dual-channel memory access technology.

The first memory slot 120 and the second memory slot 130 are coupled to the socket 110, respectively. The first memory slot 120 is used for transmitting a signal from the memory channel MCH1, and the second memory slot 130 is used for transmitting a signal from the memory channel MCH2.

In the embodiment, each of the first memory slot 120 and the second memory slot 130 has a plurality of pins. Each of the first memory slot 120 and the second memory slot 130 includes a first part of the pins PIN_p1, a second part of the pins PIN_p2 and a third part of the pins PIN_p3.

In the first memory slot 120, the first part of the pins PIN_p1 is assigned to transmit a signal from a memory card that supported by the memory channel MCH1, the second part of the pins PIN_p2 is assigned to transmit a signal from another memory card supported by the memory channel MCH1, and the third part of the pins PIN_p3 is assigned to transmit a shared signal (such as a ground signal) from the two memory cards.

Similarly, in the second memory slot 130, the first part of the pins PIN_p1 is assigned to transmit a signal from one memory card supported by the memory channel MCH2, the second part of the pins PIN_p2 is assigned to transmit a signal from another memory card supported by the memory channel MCH2, and the third part of the pins PIN_p3 is assigned to transmit a shared signal from the two memory cards.

Furthermore, the pins of the first memory slot 120 and the second memory slot 130 are defined to transmit a corresponding signal according to specifications of the memory cards that are supported by the first memory slot 120 and the second memory slot 130, respectively. In an embodiment, the pins of the first memory slot 120 and the second memory slot 130 are defined to transmit signals that comply to the signal transmission specification of double data rate third generation (DDR3). In another embodiment, the pins of the first memory slot 120 and the second memory slot 130 are defined to transmit signals that comply to the signal transmission specification of double data rate fourth generation (DDR4).

In the embodiment, according to the configuration, the processor CPU is configured to support the double channel memory access technology, and the two memory slots 120, 130 are equipped. In other embodiments, the configurations on the motherboard are varied. In an embodiment, the socket 110 is adapted to a processor with a single memory channel (which also supports two memory cards) and the motherboard 100 includes one memory slot. Pins of the memory slot are configured similarly to those of the first memory slot 120 or the second memory slot 130 in the above embodiment.

In an embodiment, the motherboard includes, but not limited to, a socket and at least one memory slot. The socket is adapted to a processor with at least one memory channel, and the memory slot includes two different parts of pins for transmitting signals from different memory cards.

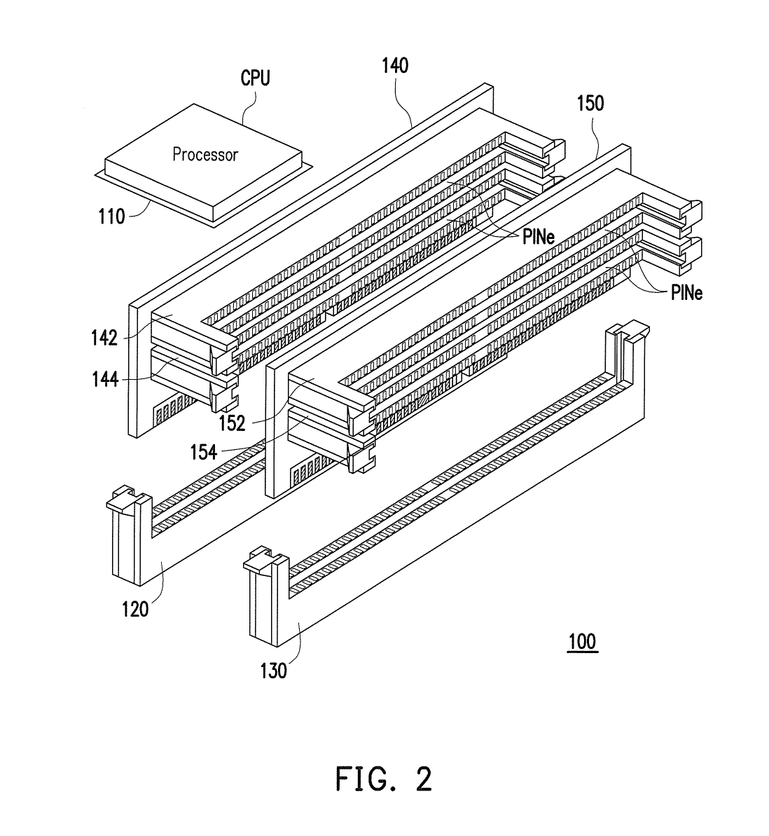

In the embodiment, the motherboard 100 is configured with at least one expanded module. The expanded module is adapted to be installed in the first memory slot 120 or the second memory slot 130 to provide additional memory slots for the motherboard 100. As shown in FIG. 2, in an embodiment, two expanded modules 140, 150 are configured corresponding to the first memory slot 120 and the second memory slot 130, respectively.

In the embodiment, the expanded module 140 includes expanded memory slots 142,144, and the expanded module 150 includes expanded memory slots 152,154. In the embodiment, each of the expanded memory slots 142, 144, 152 and 154 includes a plurality of pins PINe.

The expanded modules 140 and 150 include connection interfaces corresponding to the first memory slot 120 and the second memory slot 130, respectively. The expanded modules 140 and 150 are installed into the first memory slot 120 and the second memory slot 130 via the connection interfaces, respectively. The first memory slot 120 and the second memory slot 130 are thereby coupled to the expanded memory slots 142, 144, 152 and 154 via the circuit layout in the expanded modules 140 and 150, respectively.

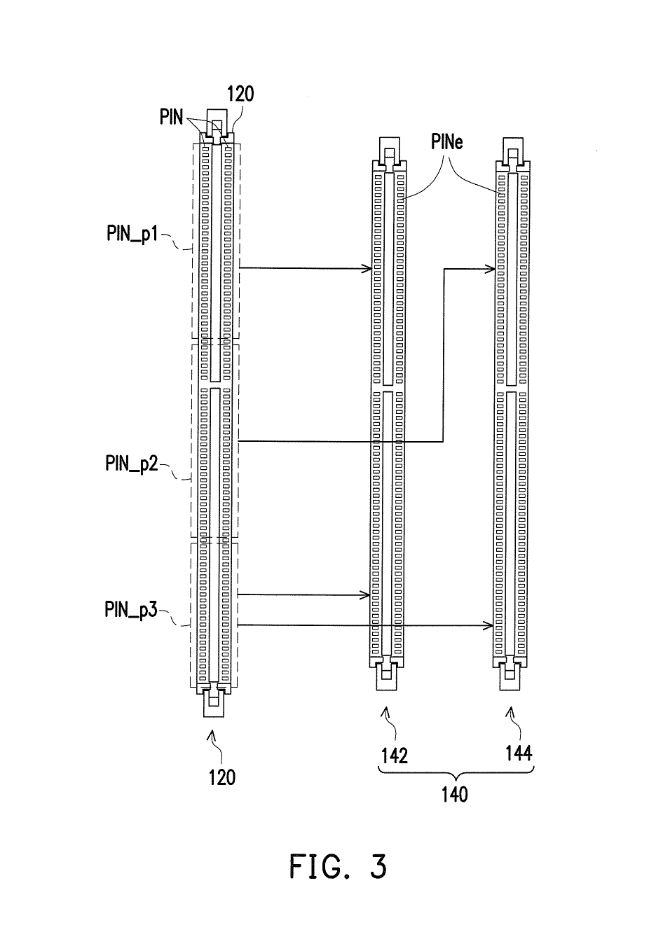

With the circuit layout in the expanded modules 140 and 150, signals from certain parts of the pins PIN_p1˜PIN_p3 of the memory slots 120 and 130 are assigned to the pins PINe of the expanded memory slots 142, 144, 152 and 154, and then the memory slots are expanded from two to four. The configuration of circuits is shown in FIG. 3.

Referring to FIG. 3, a connection between the memory slot 120 and the expanded module 140 is illustrated. When the expanded module 140 is inserted into the memory slot 120, the expanded memory slot 142 is coupled to the first part of the pins PIN_p1 and the third part of the pins PIN_p3 of the memory slot 120 via the circuit layouts in the expanded module 140. Then, the signals in the first part of the pins PIN_p1 and the third part of the pins PIN_p3 of the memory slot 120 are transmitted to the pins PINe of the expanded memory slot 142_1.

On the other hand, the expanded memory slot 144 of the expanded module 140 is coupled to the second part of the pins PIN_p2 and the third part of the pins PIN_p3 of the memory slot 120 via the circuit layouts in the expanded module 140. Then, the signals in the second part of the pins PIN_p2 and the third part of the pins PIN_p3 of the memory slot 120 are transmitted to the pins PINe of the expanded memory slot 144.

A connection and configuration of the memory slot 130 and the expanded module 150 are similar to those of the above memory slot 120 and the expanded module 140, the description of which is omitted herein.

In the embodiment of the motherboard 100, the first memory slot 120 transmits a signal from the single memory channel MCH1, and the second memory slot 130 transmits a signal from the single memory channel MCH2. Therefore, circuits would not be tangled at adjacent memory slots (i.e., the first memory slot 120 and the second memory slot 130). Consequently, when the motherboard 100 is overclocked (with two memory cards inserted into the first memory slot 120 and the second memory slots 130, respectively), the signal transmission quality of the motherboard 100 would not be affected by residual circuits between the two adjacent memory slots, and an overclocking of the motherboard 100 is stable.

In the embodiment, with the configuration of the expanded module 140, the signals in the memory slot 120 are assigned to the corresponding expanded memory slots 142, 144, and with the configuration of the expanded module 150, the signals in the memory slot 130 are assigned to the corresponding expanded memory slots 152, 154. When an expanded memory capacity is needed, at least four memory cards can be inserted onto the motherboard 100 via the expanded modules 140 and 150. Consequently, the memory capacity of the motherboard 100 is improved.

The motherboard 100 and the expanded modules 140 and 150 provide a high memory capacity expansion capacity in comparison with a conventional motherboard with two memory slots that supports a dual-channel technology. On the other hand, the circuit layout of the memory slots 120 and 130 in the embodiment reduces an impact on the signal transmission quality due to the residual circuits in comparison with a conventional motherboard with four memory slots that supports a dual-channel technology. Therefore, the memory overclocking performance and the memory capacity of the motherboard 100 are balanced.

Different configurations of the motherboard for different usage scenarios are illustrated in FIG. 4A and FIG. 4B. FIG. 4A is a schematic diagram showing a configuration of a motherboard in an embodiment. FIG. 4B is a schematic diagram showing a configuration of a motherboard in another embodiment.

In an embodiment, the motherboard is configured as shown in FIG. 4A when an overclocking is to be executed. Two memory cards RAM1 and RAM2 are inserted into the memory slots 120 and 130, respectively. The processor accesses the memory card RAM1 inserted in the first memory slot 120 via the memory channel MCH1, and accesses the memory card RAM2 inserted in the second memory slot 130 via the memory channel MCH2.

In an embodiment, the motherboard is configured as shown in FIG. 4B when more than two memory cards are utilized to expand the memory capacity. The expanded modules 140 and 150 are installed into the first memory slot 120 and the second memory slot 130, respectively. The memory cards RAM1˜RAM4 are inserted into the expanded memory slots 142, 144, 152 and 154, respectively. Please also Refer to FIG. 3, the first part of the pins PIN_p1 and the third part of the pins PIN_p3 of the first memory slot 120 are coupled to the pins PINe of the expanded memory slot 142 via the circuit layouts in the expanded module 140, and the second part of the pins PIN_p2 and the third part of the pins PIN_p3 of the first memory slot 120 are couple to the pins PINe of the expanded memory slot 144 via the circuit layouts in the expanded module 140. As a result, the processor CPU accesses the memory cards RAM1 and RAM2 (which are inserted into the expanded memory slots 142 and 144, respectively) via the circuit layout and the pins.

Similarly, the first part of the pins PIN_p1 and the third part of the pins PIN_p3 of the second memory slot 130 are coupled to the pins PINe of the expanded memory slot 152 via the circuit layout in the expanded module 150, and the second part of the pins PIN_p2 and the third part of the pins PIN_p3 of the second memory slot 130 are coupled to the pins PINe in the expanded memory slot 154 via the circuit layout in the expanded module 150. As a result, the processor assesses the memory cards RAM3 and RAM4 (which are inserted into the expanded memory slots 152 and 154, respectively) via the circuit layout and the pins.

In an embodiment, the expanded modules 140 and 150 are different in size, so that the inserted memory cards RAM1˜RAM4 occupied less space such that more layout region on the motherboard 100 is achieved. As shown in FIG. 4C, in the embodiment, a length L1 of the expanded module 140 is larger than a length L2 of the expanded module 150, and thus, the expanded memory slots 142 and 144 are positioned higher than the expanded module 150.

In an embodiment, the pins PINe of the expanded memory slots 142, 144, 152 and 154 are defined using a same/different signal transmission specification with the pins of the memory slots 120 and 130, so that a hardware compatibility of the motherboard 100 is improved.

In an embodiment, the first memory slot 120 and the second memory slot 130 support DDR4 signal transmission specification and the pins PINe of the expanded memory slots 142, 144, 152 and 154 are also defined to support DDR4 signal transmission specification. Then, the expanded memory slots 142, 144, 152 and 154 also support DDR4 memory cards RAM1˜RAM4.

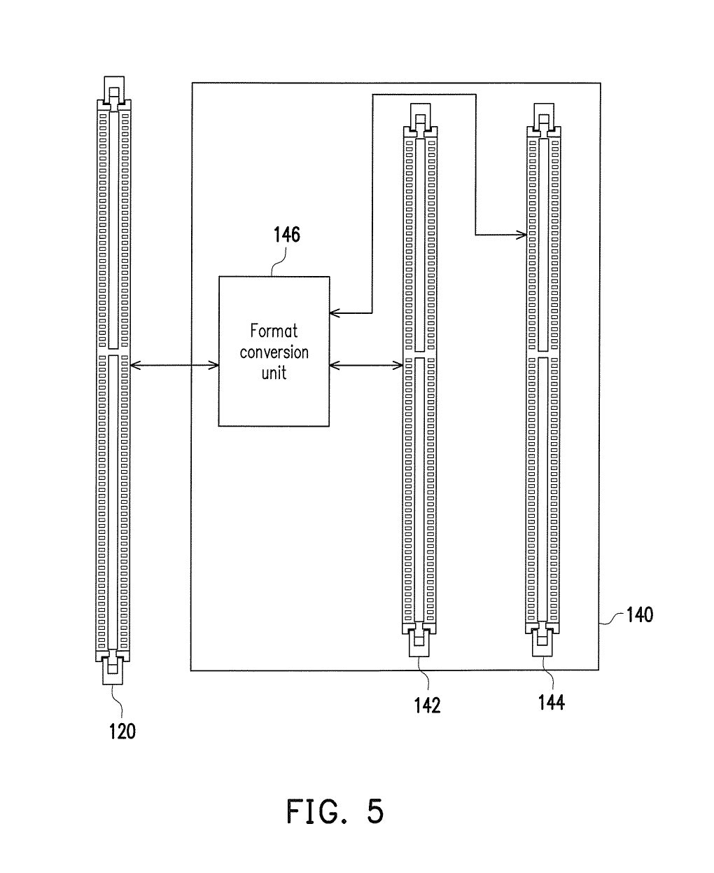

In an embodiment, the pin PINe of the expanded memory slots 142, 144, 152 and 154 are defined to support DDR3 signal transmission specification that is different from the pins of the first memory slot 120 and the second memory slot 130 which are defined to support DDR4 signal transmission specification, each of the expanded modules 140 and 150 further includes a specification conversion unit (as shown in FIG. 5) to convert the signal transmission specification of the signals transmitted from the pins of the first memory slot 120 or the second memory slot 130 to the DDR3 signal transmission specification for the expanded memory slots 142, 144, 152 or 154. FIG. 5 is a schematic diagram showing an expanded module in an embodiment.

Referring to FIG. 5, an expanded module 140 is exemplified in the embodiment. In the embodiment, the expanded module 140 further includes a specification conversion unit 146, besides the expanded memory slots 142 and 144. The specification conversion unit 146 is coupled to the expanded memory slots 142 and 144. The specification conversion unit 146 converts the signal transmission specification of the signals received from the first memory slot 120 to the DDR3 signal transmission specification. And then, the signals transmitted to the pins of the expanded memory slots 142 and 144 conform to the DDR3 signal transmission specification. As a result, the expanded memory slots 142, 144, 152 and 154 support DDR3 memory cards RAM1˜RAM4, and thus a hardware compatibility of the motherboard 100 is improved.

In above embodiments, only the socket 110, the first memory slot 120 and the second memory slot 130 are shown at the motherboard 100 in figures for a clear purpose, however, a north bridge chip, a south bridge chip, a radiator, a hard disk slot, a slot for power supply and other slots for some peripheral devices also may be configured according to a practical requirement.

In sum, according to the motherboard in the embodiments, the signals from different memory cards can pass through the same memory slot. Therefore, residual circuits have less impact to the overclocking performance. Furthermore, with the configuration of the expanded modules, the motherboard has expanded memory capacity. Therefore, the overclocking performance and the memory capacity are both taken into consideration.

Although the invention includes been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. A motherboard comprising:
a socket adapted for disposing a processor with at least one memory channel, wherein each of the memory channels supports at least two memory cards; and
a memory slot coupled to the socket and transmitting signals from the memory channel, wherein the memory slot includes a plurality of pins, a first part of the pins of the memory slot is assigned to transmit a signal from one of the memory cards supported by the memory channel, and a second part of the pins of the memory slot is assigned to transmit a signal from another one of the memory cards supported by the memory channel.

2. The motherboard according to claim 1, wherein a third part of the pins of the memory slot is assigned to transmit a shared signal of the memory cards.

3. The motherboard according to claim 2, wherein the motherboard further includes:
an expanded module for installed into the memory slot, wherein the expanded module includes a first expanded memory slot and a second expanded memory slot, the first expanded memory slot and the second expanded memory slot include a plurality of pins, respectively.

4. The motherboard according to claim 3, wherein the first expanded memory slot is coupled to the first part of the pins and the third part of the pins when the expanded module is inserted into the memory slot, and the signals transmitted by the first part of the pins and the third part of the pins are assigned to the pins of the first expanded memory slot.

5. The motherboard according to claim 4, wherein when the expanded module is inserted into the memory slot, the second expanded memory slot is coupled to the second part of the pins and the third part of the pins, and the signals transmitted by the second part of the pins and the third part of the pins are assigned to the pins of the second expanded memory slot.

6. The motherboard according to claim 5, wherein the pins of the memory slot are defined in a first signal transmission specification to support the memory cards of a first configuration.

7. The motherboard according to claim 6, wherein the specification of the pins of the first expanded memory slot and the second expanded memory slot are defined the same as the pins of the memory slot to comply the first signal transmission specification.

8. The motherboard according to claim 6, wherein the expanded module further includes:
a specification conversion unit coupled to the first expanded memory slot and the second expanded memory slot, converting the signal transmission specification of the signals received from the memory slot to a second signal transmission format.

9. The motherboard according to claim 8, wherein the pins of the first expanded memory slot and the second expanded memory slot are defined based on the second signal transmission specification to support the memory cards of a second signal transmission specification.

10. The motherboard according to claim 9, wherein the memory cards of the first signal transmission specification are double data rate fourth generation (DDR4) memory cards, and the memory cards of the second signal transmission specification are double data rate third generation (DDR3) memory cards.
